(19) United States
(12) Patent Application Publication
(10) Pub. No.: US 2019/0338940 A1
(43) Pub. Date: Nov. 7, 2019

(54) Illuminated Safety Rail and Ladder

(71) Applicant: James Lee Shepherd, Bradenton, FL (US)

(72) Inventor: James Lee Shepherd, Bradenton, FL (US)

(21) Appl. No.: 16/213,753

(22) Filed: Dec. 7, 2018

Related U.S. Application Data
(60) Provisional application No. 62/665,069, filed on May 1, 2018.

(51) Int. Cl. F21V 33/00; F21V 3/02; F21V 31/00; F21V 23/04; E06C 7/00; B63B 27/14; E06C 5/34

(52) U.S. Cl. CPC F21V 33/006; F21V 3/02; F21V 31/00; F21Y 2115/10; E06C 7/003; B63B 27/14; E06C 5/34; F21V 23/0435

(57) ABSTRACT

The invention discloses an illuminated safety rail apparatus contained within a watertight, translucent or transparent tubular-shaped housing. The housing may be manufactured from a plastic or polymer material. The shape of the safety rail may vary and be customized to accommodate various sizes and configurations of railings and ladders, such as a commonly used return-to-deck style handrails for pools and spas; safety rails for indoor and outdoor stairwells and walls of any structure; docks and dock ramps; and for travel trailers and motor homes. The housing also contains watertight maintenance access points. The apparatus contains LED or other energy efficient lights that illuminate the safety rail and the surrounding area and has the additional benefit of creating a pleasant aesthetic effect.

### FIELD OF INVENTION

The invention relates to a product in the field of illuminated handrails and ladders; specifically, return-to-deck style handrails and ladders for pools and spas, and handrail and ladders for docks, travel trailers and motor homes.

### BACKGROUND OF THE INVENTION

The present invention meets a long felt need in the field of safety hand rails to provide an illuminated feature that acts as both a functional safety feature while being aesthetically pleasing. The present invention addresses this long felt need by disclosing a product that is easy to install, use and maintain, as well as being aesthetically pleasing, safe, durable, practical, and relatively inexpensive to manufacture.

The present invention also discloses embodiments to new and unique safety handrails and ladders for pools, spas, stairwells, docks, travel trailers and motor homes, none of which are found in the prior art.

Several attempts have been made to create similar illuminated hand rails, including those found in the following prior art: U.S. Pat. No. 9,746,152, issued Aug. 29, 2017 to Poole et. al.; U.S. Pat. No. 7,374,319, issued May 20, 2008 to Camarota, et. al.; U.S. Pat. No. 7,052,170, issued May 30, 2006 to Striebel; U.S. Pat. No. 3,023,832, issued Mar. 6, 1962 to Silverman; Japanese Patent No. JP 4,592,407, issued Dec. 1, 2010 to Hidetoshi, et. al.; Japanese Patent No. JP 4,431,871, issued Mar. 17, 2010 to Takeshi; Japanese Patent No. DE102005041333 dated Jan. 25, 2007 to Schillinger; and Japanese Patent No. JP 2001271473 dated Oct. 15, 2001 to Katsumi.

None of these prior art inventions and patents, either individually or in combination, describe the present invention as disclosed and claimed herein.

### SUMMARY OF THE INVENTION

The invention discloses an illuminated safety rail apparatus contained within a watertight, translucent or transparent tubular-shaped housing. The housing may be manufactured from a plastic or polymer material. The shape of the safety rail may vary and be customized to accommodate various sizes and configurations of railings and ladders, such as a commonly used return-to-deck style handrails for pools and spas; safety rails for indoor and outdoor stairwells and walls of any structure; docks and dock ramps; and for travel trailers and motor homes. The housing also contains watertight maintenance access points. The apparatus contains LED or other energy efficient lights that illuminate the safety rail and the surrounding area and has the additional benefit of creating a pleasant aesthetic effect.

The light-emitting source contained within and running through the housing may be a series of LED or other energy efficient light source and may be powered by an alternating current or direct current source that can be either contained within the watertight access point of the housing, a wall outlet, or an external power source such as 12V battery, solar panel, or any other means known in the art. An IR or other NFC remote controller may be contained in the watertight access point to allow for changing of light intensity, color, setting a timer on the lights, or to turn the lights on and off. The lights themselves may vary in intensity and color to create a pleasing aesthetic effect.

For the pool and spa embodiment of the invention, the safety rail illuminates both the water and the immediate surrounding area. This results in functionality both in regard to safety in providing light to the surrounding area as well as creating an aesthetic effect. Any pre-existing pools and spas can be easily retrofitted to accommodate the invention with minimal expense. The invention can be permanently installed on a pool deck or be removeable.

A first object of the invention is to provide an illuminated safety rail or ladder that provides light to the surrounding surface area to enhance visibility and overall safety.

A second object of the invention is to provide an illuminated safety rail or ladder whose light creates an aesthetically pleasing and fun ambiance as an additional inherent benefit to the safety functionality of the invention.

The above and other objects, features and advantages of the present invention should become more readily apparent to those skilled in the art upon a reading of the following detailed description in conjunction with the drawings, wherein there is shown and described illustrative embodiments of the invention.

### BRIEF DESCRIPTION OF THE DRAWINGS

In the following description, reference will be made to the attached drawings in which:

FIG. 1 is an isometric view of the illuminated return-to-deck style pool safety rail embodiment as disclosed by the present invention.

FIG. 2 is a side view of the illuminated return-to-deck style pool safety rail embodiment disclosed in the present invention, showing detail of the reinforcement for securing anchors and the watertight maintenance access point.

FIG. 3 is an isometric view of the illuminated safety rail embodiment disclosed by the present invention as applied for use in a stairwell, using a hard-wired line power source.

FIG. 4 is an isometric view of the illuminated safety rail embodiment disclosed by the present invention as applied for use in a stairwell, incorporating a solar panel and 12V battery as a power source.

FIG. 5 is an isometric view of the illuminated safety rail embodiment disclosed by the present invention as applied for use along a wall. This embodiment is shown incorporating a solar panel and 12 volt battery as a power source but can also be manufactured to use a hard wired, line power as in the stairwell embodiment shown in FIG. 3.

FIG. 6 shows an isometric view of the illuminated pool ladder embodiment disclosed by the present invention.

### DESCRIPTION OF THE PREFERRED EMBODIMENTS

For purposes of describing the preferred embodiment of the present invention, the terminology used in reference to the numbered components in the drawings is as follows:
100 return to deck shaped safety rail apparatus
101 ladder shaped apparatus
102 safety rail apparatus embodiment for stairwell
103 safety rail apparatus embodiment for a wall
104 device interface
106 remote control
108 access port/battery access and housing for device interface
110 base of safety rail leg
116 seated rail legs
118 deck anchors for rail
120 LED lights
122 top surface of step/rung
124 step/rung of ladder
126 wall brackets
130 line power
132 solar panel
134 mounting coupling
136 12 volt battery

In each embodiment of the invention, the apparatus provides both the safety features of a traditional hand rail experience, with the added benefit of illumination, and the aesthetically pleasing effect of the lighted elements, be they traditional soft light or a multicolored light experience.

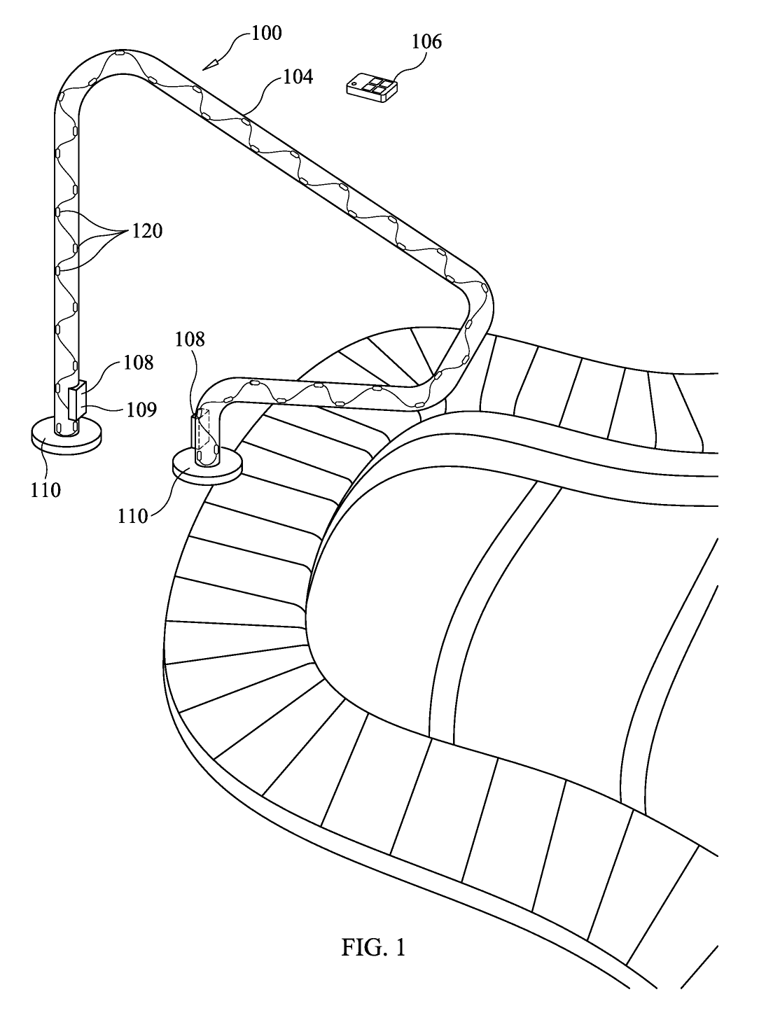

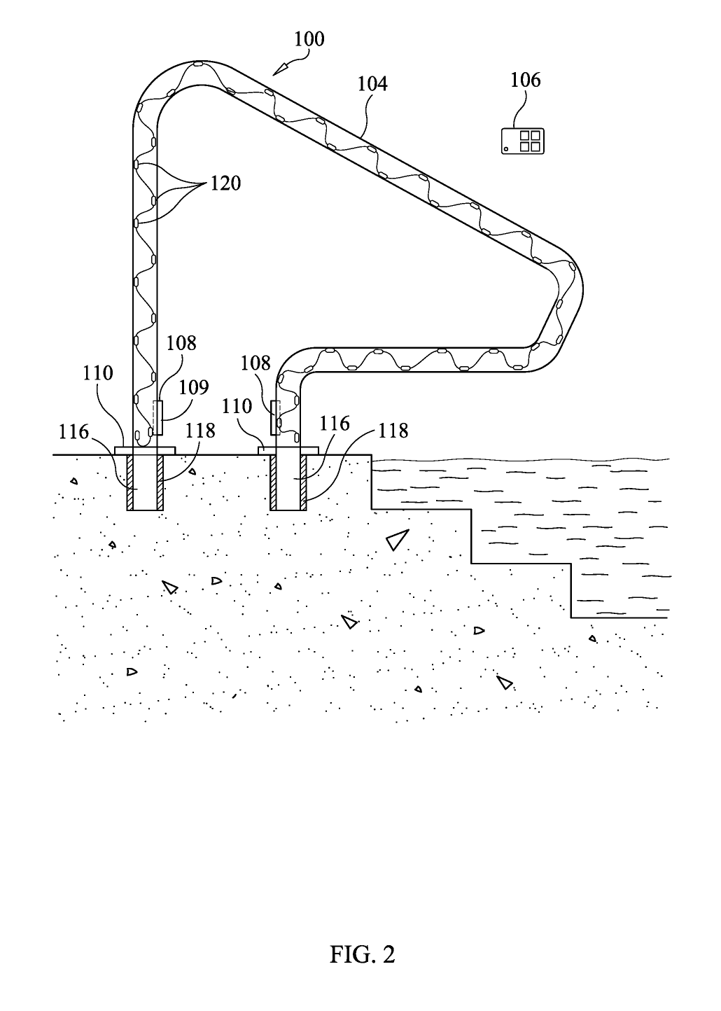

With reference to the drawings, the preferred embodiment of the invention, as shown in FIGS. 1 and 2, provides an illuminated return-to-deck shaped safety rail apparatus (100) for a pool or spa. A transparent or translucent housing (104) contains a lighting element comprising a series of connected 12 volt LED's or other energy efficient bulbs (120), connected in either series or parallel, and all running to a power source affixed to the invention. This power source may be a battery terminal (109), such as a 12 volt battery connection (136); a direct line current (130); a solar panel with a 12 volt battery connection (132, 136), or other means known in the art.

The housing (104) of the apparatus has at least one access port (108) providing means of accessing the LED light elements (120) for maintenance and repairs of the device interface hardware (104) or to replace any LED's (120) as needed. The preferred embodiment of the invention may incorporate a battery pack (109) as its power source, said battery pack being accessible via a watertight access point (108) on the housing (104).

This return-to-deck embodiment of the invention is affixed to the deck of the pool or spa and can be either permanently installed to the deck or can be made removable as desired. For pre-existing pools and spas, the deck can be fitted with anchors (118) preferably made from aluminum or other rust resistant and durable material as shown in FIGS. 1 and 2. These anchors allow the legs of the apparatus (116) to seat securely on the pool deck. The invention can be further secured with a wedge and bolt (not shown) or other means known in the art that serves to reinforce the base of the rail posts.

The lighting element of the invention (120), when turned on, illuminates the water and the surrounding surface area. In all embodiments of the invention, various colored lights can be incorporated, and the entire lighting element can be programmed to turn on or off, change color or illuminate in patterned sequence. The apparatus illuminates the thus creates an aesthetically pleasing and fun ambiance in addition to their primary purpose as a safety feature. Control of the lighting safety features of the apparatus (100) is accomplished by using a remote control (106) having NFC, Bluetooth, or other wireless means communication, that can send and receive signals to and from a device interface (104) that is wired into the apparatus (100). The device interface (104) has a data processor and a memory, and computer instructions that enable via wireless remote control functionality to turn the lights (120) on or off; cycle through various colors of lights (120); set a timer for turning the lights on or off; or other commands not explicitly disclosed herein.

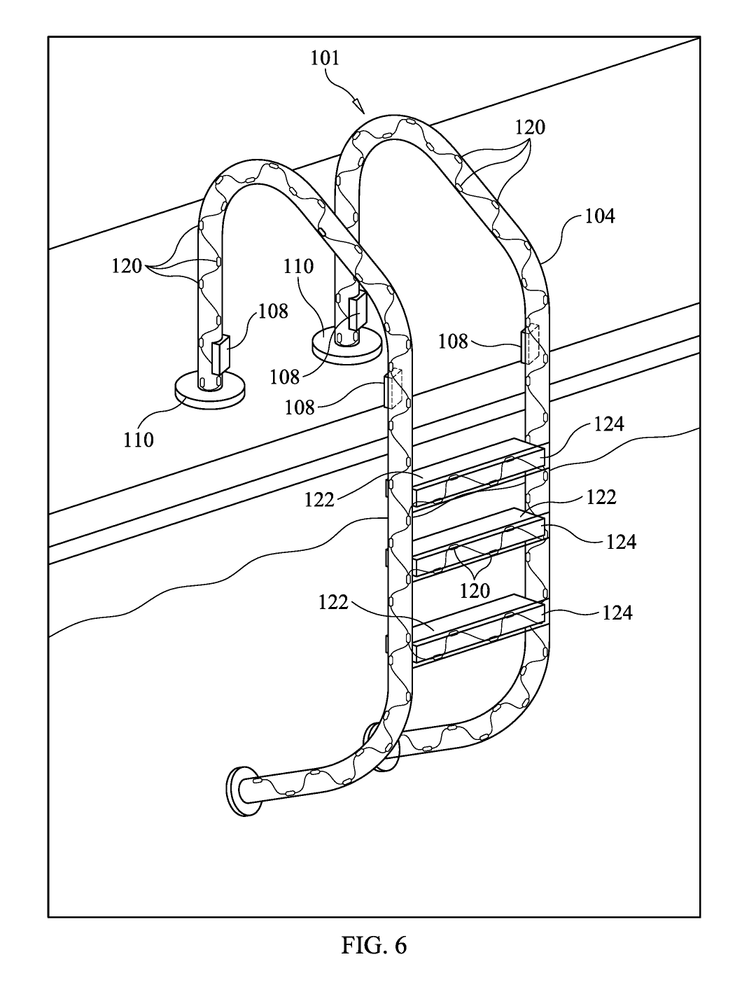

A second preferred embodiment of the invention is an illuminated safety ladder apparatus (101) that can be permanently installed or can be made removable if desired. The safety ladder embodiment (101) can be designed to be incorporated into a pool or spa as shown in FIG. 6, or can be manufactured for use on boat docks, or on travel trailers and motor homes that would normally incorporate a ladder element. Like the return-to-deck style embodiment (100) of FIGS. 1 and 2, the safety ladder embodiment would have at least one access port (108), means of anchoring the legs (110) of the apparatus to a surface, and a device interface means to control the LED lighting elements (120). The ladder embodiment (101) further comprises at least one step or rung (124), each rung having by LEDs or lights (120) by which they may be illuminated, and an upper surface (122) that may have a textured non-slip coating.

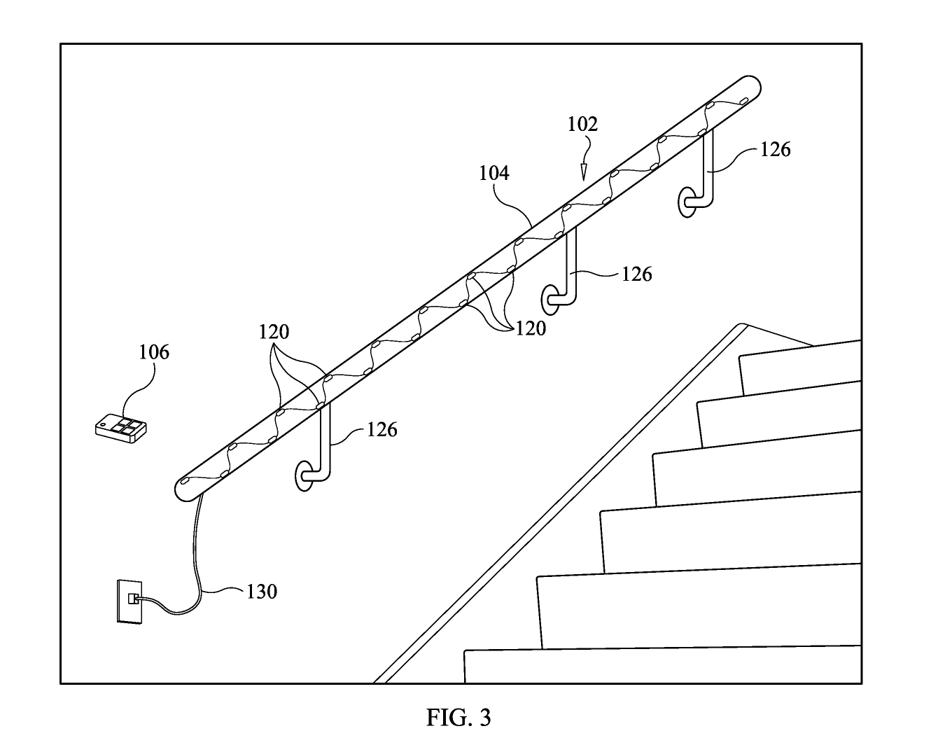

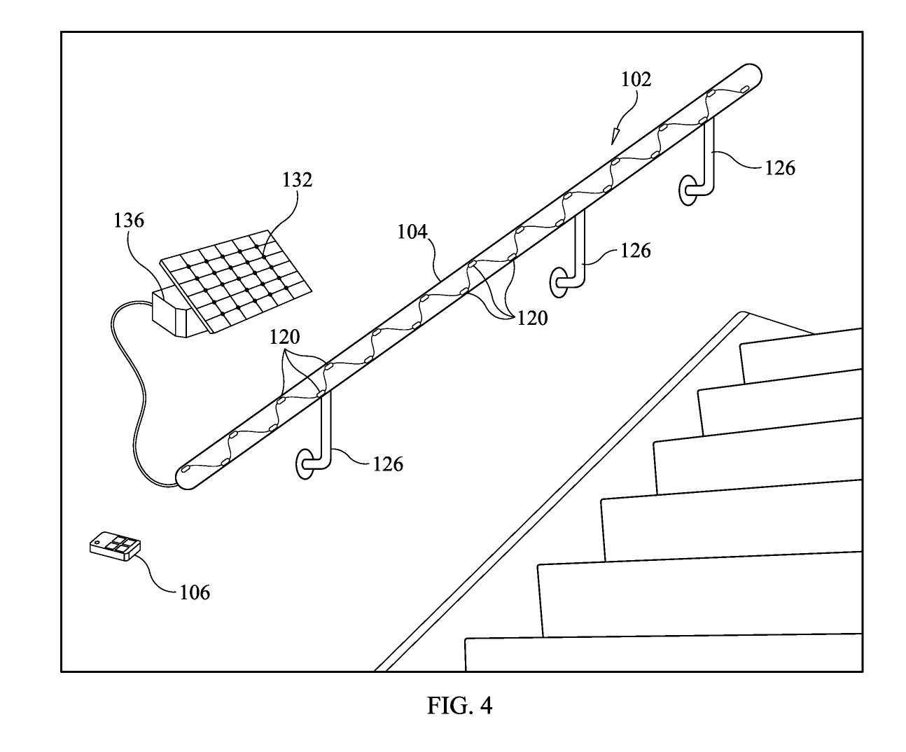

An additional embodiment of the invention is shown in FIGS. 3 and 4, wherein the illuminated safety rail of the present invention is applied for use in a stairwell. FIG. 3 shows this embodiment (102) of the present invention as incorporated into an indoor stairwell using brackets (126) or other means known in the art. In this embodiment, the illuminated safety rail (102) is configured into a banister (104) and is programmed to light up and illuminate a stairwell, providing additional safety feature over the prior art. The safety rail may be powered by direct line current (130), or 110 volt current converted to 12 volt power, or other means known in the art. In the outdoor version shown in FIG. 4, the apparatus can be powered via a solar panel (132) and 12 volt battery (136) means.

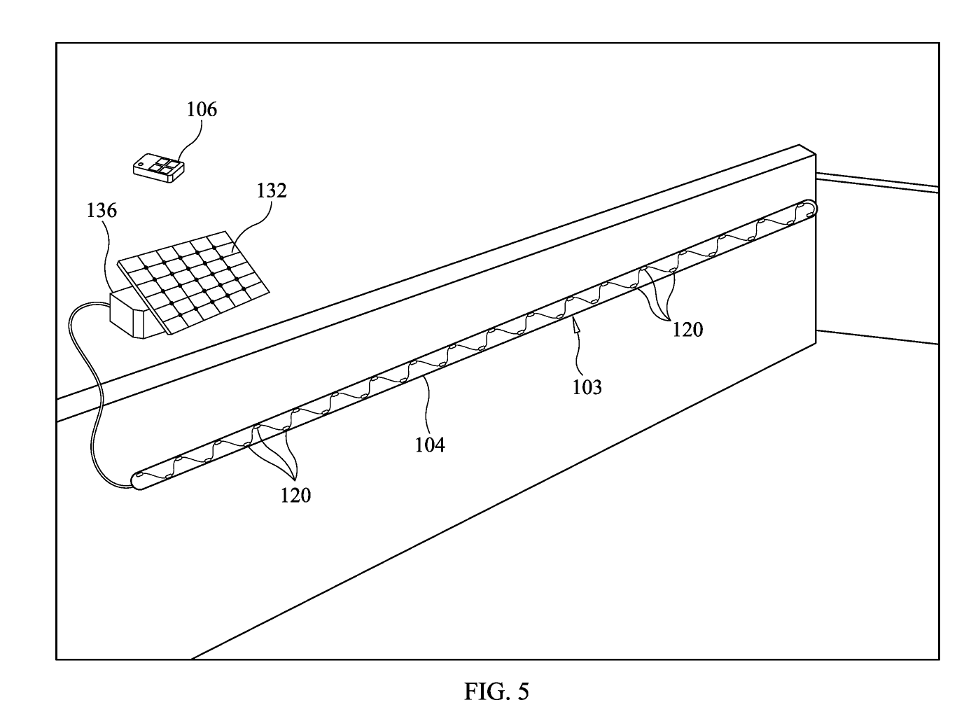

A further additional embodiment of the invention is the illuminated safety handrail (103) shown in FIG. 5. This safety handrail (103) can be powered by 110 volt reduced down to 12 volt power (136), via a solar panel (132) wired to the safety rail (103). The apparatus can be programed via the remote control (106) and device interface to be on a time to turn on at dusk and turn off at dawn, or at other specific time intervals.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having described the present invention, what is claimed is:

1. An illuminated safety rail, comprising:
rat least one hollow tube, being either translucent or transparent material;
at least one string of lights running through the inner length of each said rail;
said lights connected to a power source that is accessible from and connected to said rail;
at least one watertight access port along said rail to allow access to maintain said lights and said power source;
means of mounting said rail to a surface;
and wherein said illuminated safety rail can be manufactured in forms for use as rails for pools, spas, boat docks, and hand rails.

2. The apparatus of claim 1, wherein said lights are comprised of LED lights.

3. The apparatus of claim 1, where said lights are comprised of energy efficient light bulbs.

4. The apparatus of claim 2, wherein said power source is at least one battery contained in a housing on apparatus and directly connected to said lights.

5. The apparatus of claim 2, wherein said power source is a wired connection to a line power source.

6. The apparatus of claim 5, wherein said power source is connected to a device interface, enabling said apparatus to be controlled by a wireless remote device or remote electric panel.

7. The device interface of claim 6, having a data processor and a memory; and computer instructions loaded into said memory in a non-transitory computer-readable medium that when executed are configured to instruct said interface to carry out instructions loaded into the memory to turn said lights on or off; cycle through various colors of said lights; set a timer for turning said lights on or off; or other commands loaded into the memory and capable of being processed by the data processor to generate signals corresponding to the various commands received by the wireless control device.

8. The apparatus of claim 2, whereby said lights illuminate the surrounding surface area and create a fun and aesthetically pleasing ambiance.

9. The apparatus of claim 1, wherein said hollow tubular rail comprises a pool ladder.

10. The apparatus of claim 1, wherein said hollow tubular rail comprises a ladder for boat docks.

11. The apparatus of claim 1, wherein said hollow tubular rail comprises a ladder for trailers and motor homes.

12. The apparatus of claim 1, wherein said hollow tubular rail comprises a return-to-deck style safety rail for swimming pools, spas, tubs, or jacuzzies.

13. The apparatus of claim 1, wherein said hollow tubular rail comprises a safety hand rail or guard rail.
